(19) United States
(12) Patent Application Publication
(10) Pub. No.: US 2007/0264024 A1
(43) Pub. Date: Nov. 15, 2007

(54) Bi-directional application of a dispersion compensating module in a regional system

(75) Inventors: Wenxin Zheng, Ellicott city, MD (US); Harshad P. Sardesai, Ellicott City, MD (US); Jean Luc Archambault, Severna Park, MD (US); Michael Y. Frankel, Baltimore, MD (US)

Correspondence Address: CLEMENTS WALKER, 1901 ROXBOROUGH ROAD, SUITE 300, CHARLOTTE, NC, 28211, US

(73) Assignee: CIENA CORPORATION, Linthicum, MD (US)

(21) Appl. No.: 11/414,124

(22) Filed: Apr. 28, 2006

(51) Int. Cl. H04B 10/12

(52) U.S. Cl. 398/147

(57) ABSTRACT

A system for the bidirectional application of a dispersion compensating module in a regional system includes a dispersion compensating module configured to receive a first optical signal traveling along a first path and a second optical signal traveling along a second path, wherein the dispersion compensating module provides dispersion compensation to the first optical signal and the second optical signal. The system also includes a first circulator in optical communication with the dispersion compensating module and the first path, wherein the first circulator delivers the first optical signal to the dispersion compensating module. The system further includes a second circulator in optical communication with the dispersion compensating module and the second path, wherein the second circulator delivers the second optical signal to the dispersion compensating module. The first circulator is further in optical communication with the second path, receives the second optical signal from the dispersion compensating module, and transmits the second optical signal along the second path subsequent to dispersion compensation. The second circulator is further in optical communication with the first path, receives the first optical signal from the dispersion compensating module, and transmits the first optical signal along the first path subsequent to dispersion compensation.

### CROSS-REFERENCE TO RELATED APPLICATION(S)

The present non-provisional patent application claims the benefit of priority of U.S. Provisional Patent Application No. 60/875,449 (Wenxin ZHENG, Harshad SARDESAI, and Jean Luc ARCHAMBAULT), filed on Apr. 28, 2005, and entitled “BI-DIRECTIONAL APPLICATION OF A DISPERSION COMPENSATING MODULE IN A REGIONAL SYSTEM,” which is incorporated in-full by reference herein.

### FIELD OF THE INVENTION

The present invention relates generally to the optical transmission and optical networking fields. More specifically, the present invention relates to the bi-directional application of a dispersion compensating module (DCM) in a regional system. Advantageously, the systems and methods of the present invention have the potential to reduce dispersion compensation costs in optical transmission systems by nearly 50%.

### BACKGROUND OF THE INVENTION

Cost reduction in optical transmission systems using various dispersion compensation techniques has been the subject of a number of recent studies. These dispersion compensation techniques include: dispersion compensating fiber (DCF) optimization, the use of etalons, the use of fiber Bragg gratings, the use of planar light-wave circuits (PLCs), and electrical dispersion compensation (EDC) by signal pre-distortion, in addition to the use of non-zero dispersion shifted fiber (NZDSF). NZDSF is manufactured with a more perfectly circular fiber core and a more complex refractive index profile than conventional single-mode fiber, resulting in less dispersion than conventional single-mode fiber. Disadvantageously, NZDSF addresses only polarization mode dispersion (PMD), described in greater detail herein below, and exacerbates slope mismatch dispersion, also described in greater detail herein below.

DCF optimization involves placing spools of DCF at predetermined intervals along a network—approximately 15 km of DCF for approximately every 80 km of network fiber, for example. These spools of DCF are typically stacked on top of telecommunications racks. Disadvantageously, DCF optimization addresses only chromatic dispersion (CD), described in greater detail herein below, and is typically set up to accurately correct CD on a center wavelength of multiple wavelengths carried on a fiber. Thus, dispersion accumulates at the other wavelengths and creates a problem at the edge of a band of wavelength channels.

The use of etalons involves using a Fabry-Perot interferometer arranged with two flat reflecting surfaces that are aligned to be parallel, and either a transparent plate (such that reflections from both of the flat reflecting surfaces are exploited) or an air gap in between the two flat reflecting surfaces. The etalon acts as an optical resonator or cavity, optionally with controllable resonant frequency, providing CD.

The use of fiber Bragg gratings involves using multiple short lengths of fiber that each reflect a particular wavelength. Fiber Bragg gratings incorporate periodically spaced zones in a fiber core that each have a predetermined refractive index that is slightly higher than the fiber core, for example. This structure selectively reflects a predetermined range of wavelengths, while selectively transmitting other wavelengths. Fiber Bragg gratings are each typically between about 1 mm and about 25 mm long, and are formed by selectively exposing a fiber to ultraviolet (UV) light. Advantageously, fiber Bragg gratings have relatively low insertion loss when inserted into a network, as a given light wave is not routed outside of the fiber.

The use of PLCs involves using PLC chips incorporating Mach-Zehnder interferometry, for example, to compensate for CD and the like. Advantageously, these devices have relatively low insertion loss when inserted into a network, are quickly tunable, and are relatively simple to operate.

EDC by signal pre-distortion involves pre-distorting the amplitude and phase waveforms of a transmitted signal in order to achieve dispersion compensation. Advantageously, these techniques eliminate the need for bulky and expensive optical dispersion compensation components.

DCMs incorporate DCF optimization, the use of etalons, the use of fiber Bragg gratings, the use of PLCs, and/or a variety of other dispersion compensation techniques. These devices are placed in front of receivers in a network and make continual signal adjustments based on information derived from the analysis of a sample of an optical pulse as it travels through the DCM. The degree to which the optical pulse is corrected is based on its state, as read by a detector associated with the DCM. Advantageously, DCMs are either remotely or adaptively tunable, have a relatively small form factor, and are relatively inexpensive and simple to replace.

DCF optimization remains the most stable and reliable field technique. Thus, what are needed are improved systems and methods using DCMs that incorporate DCF optimization, as well as the use of etalons, the use of fiber Bragg gratings, and/or a variety of other dispersion compensation techniques. These improved systems and methods are provided by the present invention.

### BRIEF SUMMARY OF THE INVENTION

In various exemplary embodiments, the present invention provides for the bi-directional application of a DCM in a regional system. Advantageously, the systems and methods of the present invention have the potential to reduce dispersion compensation costs in optical transmission systems by nearly 50%.

In one exemplary embodiment of the present invention, a system for the bidirectional application of a dispersion compensating module in a regional system includes a dispersion compensating module configured to receive a first optical signal traveling along a first path and a second optical signal traveling along a second path, wherein the dispersion compensating module provides dispersion compensation to the first optical signal and the second optical signal. The system also includes a first circulator in optical communication with the dispersion compensating module and the first path, wherein the first circulator delivers the first optical signal to the dispersion compensating module. The system further includes a second circulator in optical communication with the dispersion compensating module and the second path, wherein the second circulator delivers the second optical signal to the dispersion compensating module. The first circulator is further in optical communication with the second path, receives the second optical signal from the dispersion compensating module, and transmits the second optical signal along the second path subsequent to dispersion compensation. The second circulator is further in optical communication with the first path, receives the first optical signal from the dispersion compensating module, and transmits the first optical signal along the first path subsequent to dispersion compensation.

In another exemplary embodiment of the present invention, a method for the bi-directional application of a dispersion compensating module in a regional system includes providing a dispersion compensating module configured to receive a first optical signal traveling along a first path and a second optical signal traveling along a second path, wherein the dispersion compensating module provides dispersion compensation to the first optical signal and the second optical signal. The method also includes providing a first circulator in optical communication with the dispersion compensating module and the first path, wherein the first circulator delivers the first optical signal to the dispersion compensating module. The method further includes providing a second circulator in optical communication with the dispersion compensating module and the second path, wherein the second circulator delivers the second optical signal to the dispersion compensating module. The first circulator is further in optical communication with the second path, receives the second optical signal from the dispersion compensating module, and transmits the second optical signal along the second path subsequent to dispersion compensation. The second circulator is further in optical communication with the first path, receives the first optical signal from the dispersion compensating module, and transmits the first optical signal along the first path subsequent to dispersion compensation.

In a further exemplary embodiment of the present invention, a dispersion compensating system includes an optical device configured to receive an optical signal traveling in a first direction, provide first dispersion compensation to the optical signal, receive the optical signal traveling in a second direction, and provide second dispersion compensation to the optical signal. The system also includes a mirror for changing the direction of travel of the optical signal from the first direction to the second direction. The system further includes a circulator in optical communication with a first path and a second path, wherein the circulator receives the optical signal traveling in the first direction from the first path and delivers the optical signal traveling in the first direction to the optical device. The circulator further receives the optical signal traveling in the second direction from the optical device and transmits the optical signal traveling in the second direction along the second path.

In a still further exemplary embodiment of the present invention, a dispersion compensating method includes providing an optical device configured to receive an optical signal traveling in a first direction, provide first dispersion compensation to the optical signal, receive the optical signal traveling in a second direction, and provide second dispersion compensation to the optical signal. The method also includes providing a mirror for changing the direction of travel of the optical signal from the first direction to the second direction. The method further includes providing a circulator in optical communication with a first path and a second path, wherein the circulator receives the optical signal traveling in the first direction from the first path and delivers the optical signal traveling in the first direction to the optical device. The circulator further receives the optical signal traveling in the second direction from the optical device and transmits the optical signal traveling in the second direction along the second path.

### BRIEF DESCRIPTION OF THE DRAWINGS

The present invention is illustrated and described herein with reference to the various drawings, in which like reference numbers denote like system components and/or method steps, as appropriate, and in which:

FIG. 1 is a schematic diagram illustrating one exemplary embodiment of the system for the bi-directional application of a DCM in a regional system of the present invention;

FIG. 2 is a schematic diagram illustrating one exemplary embodiment of a circulator used in the system for the bi-directional application of a DCM in a regional system of FIG. 1;

FIG. 3 is a schematic diagram illustrating one exemplary embodiment of a recirculation loop that is used to study noise accumulation and its dependency on frequency offset in the system for the bi-directional application of a DCM in a regional system of FIG. 1;

FIG. 4 is a plot illustrating the backward Rayleigh scattering (BRS) and stimulated Brillouin scattering (SBS) generated by a DCM in a recirculation loop;

FIG. 5 is a plot illustrating the bit error rate (BER) and quality factor (Q) measured at Loop 10 as a function of wavelength difference (AWL);

FIG. 6 is a plot illustrating the Q penalty computed with the number of loops due to backward injected light to a DCM, the Q penalty being larger for a larger optical signal-to-noise ratio (OSNR), with one OSNR case plotted;

FIG. 7 is a schematic diagram illustrating another exemplary (double-passed DCM) embodiment of the system for the application of a DCM or the like in a regional system of the present invention;

FIG. 8 is a schematic diagram illustrating a further exemplary (double-passed DCM) embodiment of the system for the application of a DCM or the like in a regional system of the present invention; and

FIG. 9 is a schematic diagram illustrating one exemplary embodiment of a in-line amplifier (ILA)/DCM configuration related to the system for the bi-directional application of a DCM in a regional system of FIG. 1.

### DETAILED DESCRIPTION OF THE INVENTION

CD is based on the principal that different colored pulses of light, with different wavelengths, travel at different speeds, even within the same mode, and is the sum of material dispersion and waveguide dispersion. Material dispersion is caused by the variation in the refractive index of the glass of a fiber as a function of the optical frequency. Waveguide dispersion is caused by the distribution of light between the core of a fiber and the cladding of a fiber, especially with regard to a single-mode fiber. CD concerns are compounded in today's high-speed transmission optical networks.

Slope mismatch dispersion is a subset of CD, and occurs in single-mode fiber because dispersion varies with wavelength. Thus, dispersion builds up, especially at the extremes of a band of wavelength channels. Slope mismatch dispersion compensation typically requires slope matching or tunable dispersion compensation at a receiver.

PMD results as light travels down a single-mode fiber in two inherent polarization modes. When the core of a fiber is asymmetric, the light traveling along one polarization mode travels faster or slower than the light traveling along the other polarization mode, resulting in a pulse overlapping with others, or distorting the pulse to such a degree that it is undetectable by a receiver. Again, PMD concerns are compounded in today's high-speed transmission optical networks. Further, PMD varies dynamically with temperature changes, infinitesimal asymmetries in the fiber core, etc., and therefore requires adaptively tunable dispersion compensation.

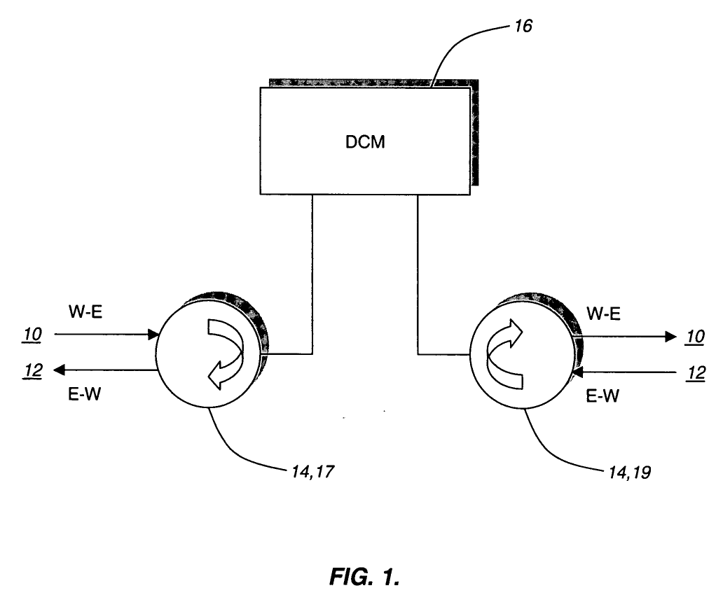

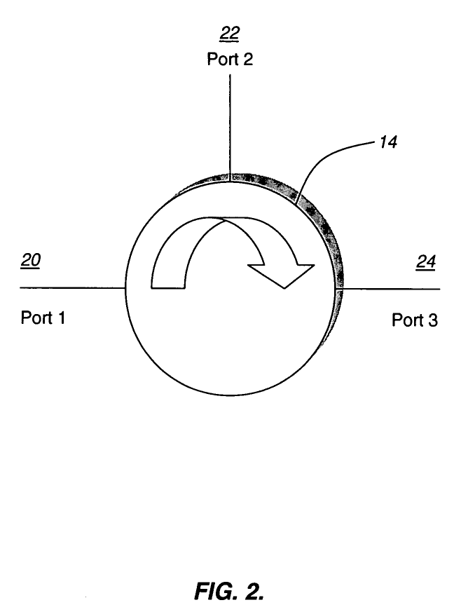

Referring to FIGS. 1 and 2, in most optical transmission systems, the total dispersion for signals propagating in a west to east (W-E) direction 10 along a route is comparable to the dispersion for signals propagating in an east to west (E-W) direction 12 along the route. Using two circulators 14, a single DCM 16 is shared at an amplifier site, for example, in both the W-E direction 10 and the E-W direction 12. In general, each of the two circulators 14 includes a first port 20 through which light enters (from the W-E direction 10 for the first circulator 17 and from the E-W direction 12 for the second circulator 19). Light that enters the first port 20 is output to a second port 22 and travels through the DCM 16, where dispersion compensation is performed, and enters the second port 22, in the embodiment illustrated, of the other circulator 14. The light that enters the second port 22 is output to a third port 24 (to the W-E direction 10 for the second circulator 19 and to the E-W direction 12 for the first circulator 17). Thus, the single DCM 16 is used to perform dispersion compensation on signals traveling in two directions simultaneously. Although the dispersion maps in both the W-E direction 10 and the E-W direction 12 are different, the net dispersion at the receiver end is the same. In regional systems where signals travel modest distances (≦1000 km), the non-optimum dispersion maps cause only modest system penalties. As described above, the DCM 16 can incorporate DCF optimization, the use of etalons, the use of fiber Bragg gratings, the use of PLCs, and/or a variety of other dispersion compensation techniques. The two circulators 14 can be placed in the DCM's empty slot. Advantageously, this bi-directional DCM embodiment reduces the cost of comparable dispersion compensation by about 45% as compared to the use of multiple DCMs.

The main concerns related to bi-directional DCM application are BRS and SBS. BRS is the backward scattering of light by particles that are smaller than the wavelength of the light. SBS is the stimulated scattering of light particles that occurs when light in a medium interacts with density variations and changes its path. These density variations can be associated with acoustic modes, such as phonons, or temperature gradients. As illustrated in FIG. 1, the noise of W-E direction signals input to the first circulator 17 gets coupled to the noise of E-W direction signals output from the first circulator 17. Likewise, the noise of E-W direction signals input to the second circulator 19 gets coupled to the noise of W-E direction signals output from the second circulator 19. In an amplifier chain, this noise and accumulate and grow very quickly with the number of spans. Because the BRS has the same wavelength as the incident light, and because the SBS has a wavelength that is about 10 to 12 GHz higher than the wavelength of the incident light, an offset between the signal frequencies propagating in the W-E direction 10 and the E-W direction 12 is needed.

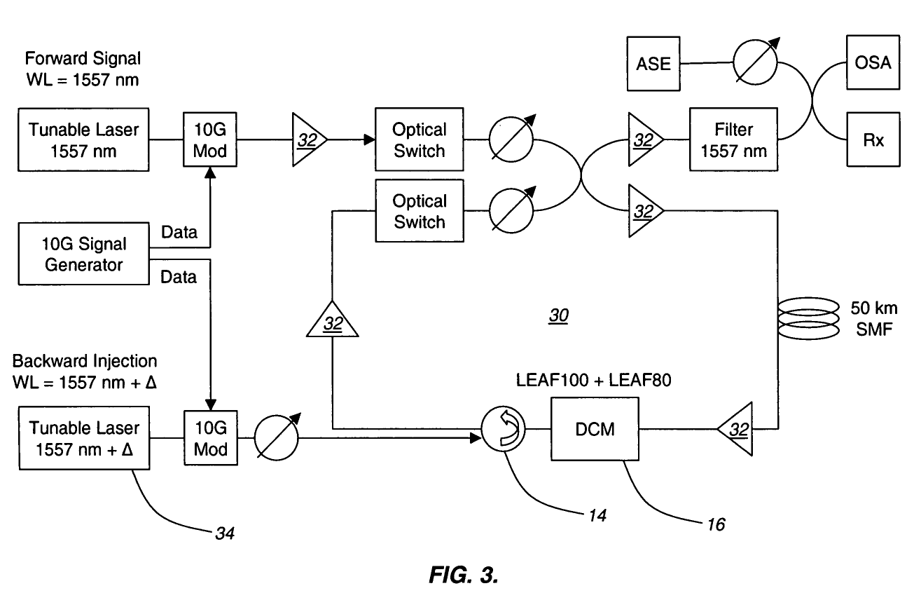

Referring to FIG. 3, a recirculation loop 30 is used to study noise accumulation and its dependency on frequency offset, and the impact of BRS and SBS induced by a backward injected signal. Only one circulator 14 is used in the recirculation loop 30, as the backward injected signal is suppressed by an isolator in each of the erbium-doped fiber amplifiers (EDFAs) 32 and cannot propagate clockwise. Two LEAF-type 100% slope compensating DCMs 16 are used in the recirculation loop 30 to match 50 km of non-dispersion shifted fiber (NDSF), as the main objective is to study the bi-directional usage of slope compensating DCF. A signal wavelength of 1557 nm is chosen so that the signal experiences negligible residual dispersion. The DCM 16 has a total return loss of about −33 dB and an SBS threshold of about +3.3 dBm. A modulated tunable laser 34 is used for backward injection, simulating the backward propagating signal. Both forward and backward lights are modulated by a 10 GHz PPP, 2ˆ23-1 PRBS signal.

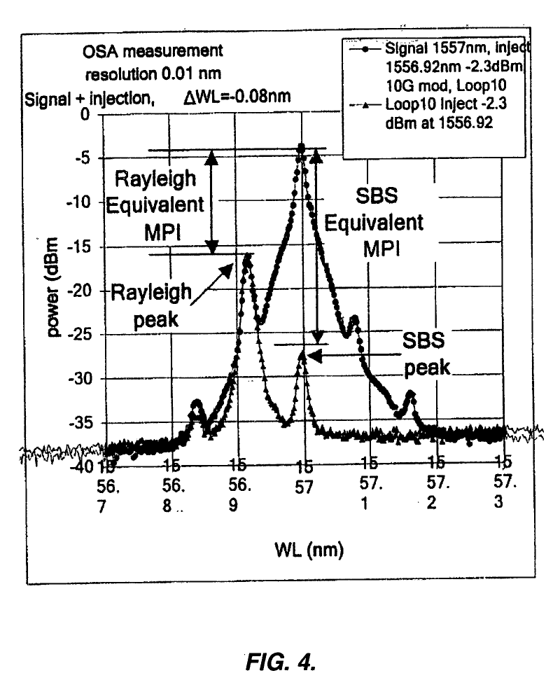

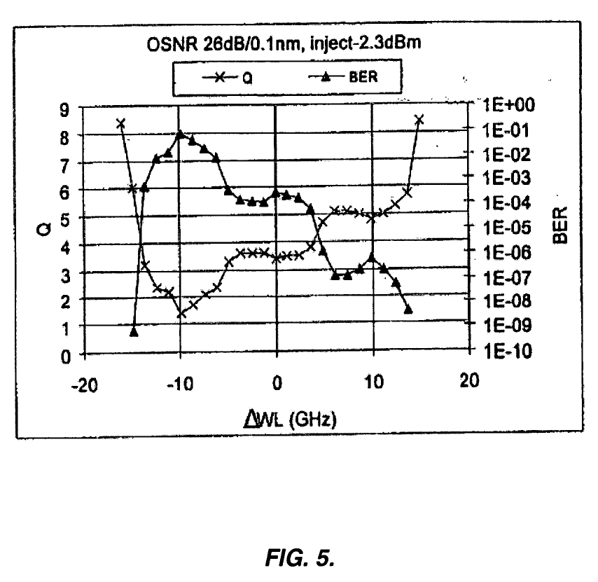

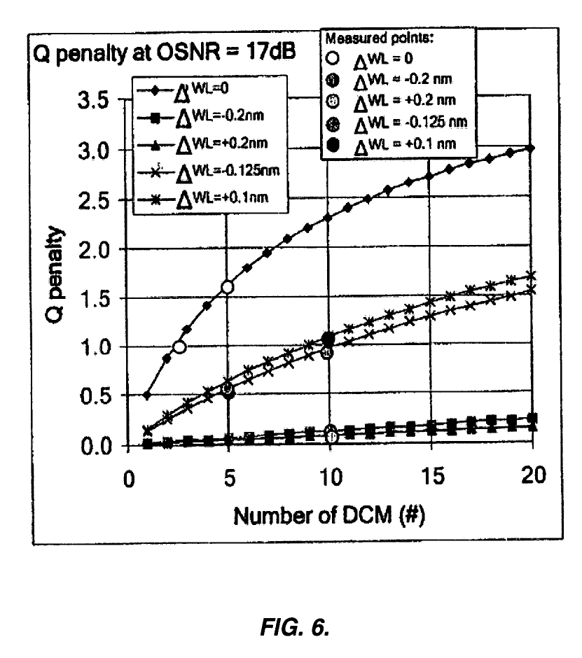

The BRS and SBS generated by the DCM 16 in the recirculation loop 30 are illustrated in FIG. 4. Although the backward power injected into the DCM is only −2.3 dBm, which is more than 5 dB lower than the SBS threshold, SBS is still clearly visible because the backscattered Stocks wave is magnified by both the amplifier chain and the DCM chain, which is pumped by the backward injected laser 34. By detuning the wavelength of the backward injected laser 34, BER and Q are measured at Loop 10. These are illustrated in FIG. 5, plotted as a function of ΔWL. The largest Q penalty is observed at ΔWL=−10 GHz due to the SBS, although the SBS peak appears to be lower than the BRS peak illustrated in FIG. 4. As illustrated in FIG. 6, the Q penalty can be simulated by assuming that BRS impairs the forward signal as equivalent multi-path interference (MPI) (see FIG. 4) and employing the formula developed for MPI analysis:
Q=[(1/Q₀²)+C·MPI]^{-1/2} (1)
where Q₀ is unimpaired Q by the equivalent MPI and C is a constant related to the eye closure factor. C=1.28 is used for all OSNR values.

The bi-directional application of a DCM 16 (FIG. 1) in a regional system, as studied and characterized in a recirculation loop 30 (FIG. 3), demonstrates that: when ΔWL is 0, the system experiences large Q penalty from BRS; when ΔWL is about 10 GHz, the system experiences even larger Q penalty from SBS; however, when AWL is greater than about 20 GHz, the system experiences negligible Q penalty after propagation through 10 DCMs. For a 50 GHz-spacing DWDM system, if the W-E and E-W signal frequencies are offset by about 25 GHz, the Q penalty from the bi-directionally applied DCM is negligible even after 20 DCMs, as illustrated in FIG. 6.

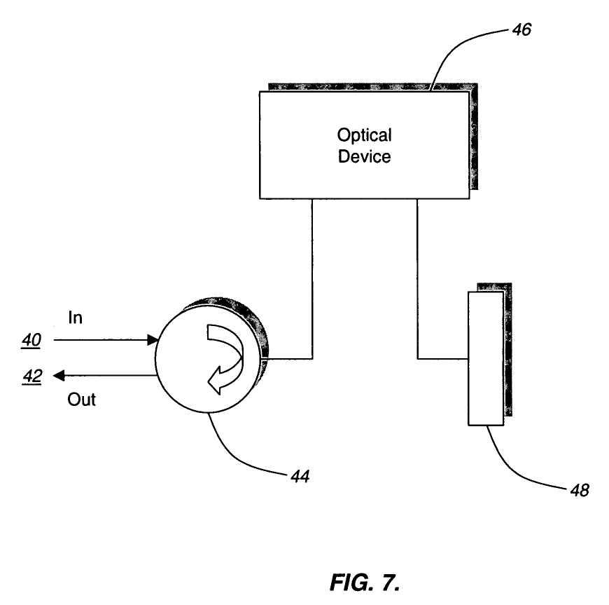

Referring to FIG. 7, in an alternative (double-passed DCM) embodiment of the present invention, light entering the input port 40 of a circulator or the like 44 is routed through an optical device 46, such as a DCM, re-configurable blocking filter (RBF), or the like, before being reflected back through the optical device 46 by a mirror 48, such as a conventional mirror, a Faraday mirror, or the like. The light exits the output 42 of the circulator or the like 44 subsequent to dispersion compensation. Advantageously, this double-passed DCM embodiment reduces the cost of comparable dispersion compensation by about 42% as compared to the use of multiple DCMs.

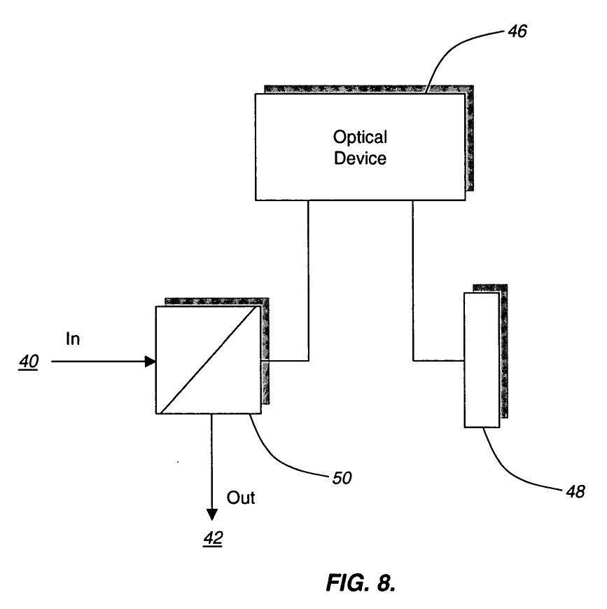

Referring to FIG. 8 in another alternative (double-passed DCM) embodiment of the present invention, light entering the input port 40 of a circulator or the like 50 is routed through an optical device 46, such as a DCM, RBF, or the like, before being reflected back through the optical device 46 by a mirror 48, such as a conventional mirror, a Faraday mirror, or the like. The light exits the output 42 of the circulator or the like 50 subsequent to dispersion compensation. Advantageously, this double-passed DCM embodiment reduces the cost of comparable dispersion compensation by about 42% as compared to the use of multiple DCMs.

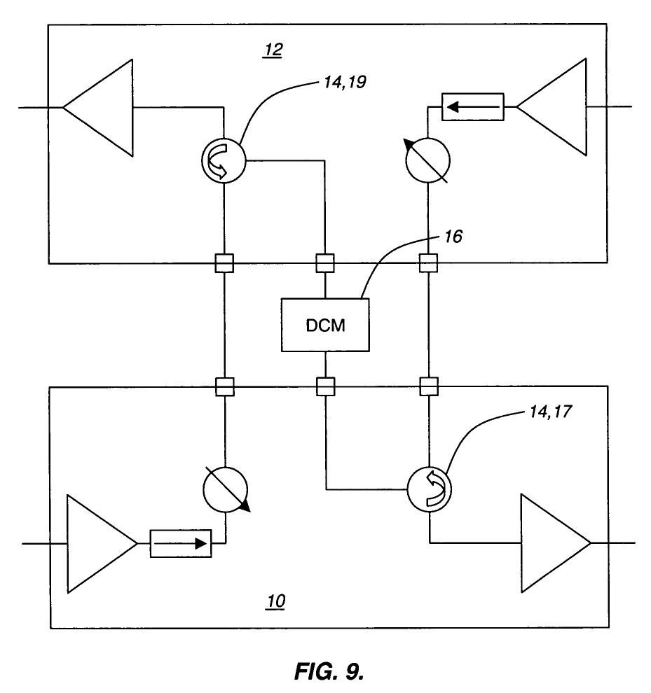

It should be noted that FIG. 9 illustrates one exemplary embodiment of an ILA/DCM configuration related to the system for the bidirectional application of a DCM in a regional system of FIG. 1.

Although the present invention has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the present invention and are intended to be covered by the following claims.

What is claimed is:

1. A system for the bi-directional application of a dispersion compensating module in a regional system, comprising:
a dispersion compensating module configured to receive a first optical signal traveling along a first path and a second optical signal traveling along a second path, wherein the dispersion compensating module provides dispersion compensation to the first optical signal and the second optical signal.

2. The system of claim 1, further comprising:
a first circulator in optical communication with the dispersion compensating module and the first path, wherein the first circulator delivers the first optical signal to the dispersion compensating module.

3. The system of claim 2, further comprising:
a second circulator in optical communication with the dispersion compensating module and the second path, wherein the second circulator delivers the second optical signal to the dispersion compensating module.

4. The system of claim 3, wherein the first circulator is further in optical communication with the second path, receives the second optical signal from the dispersion compensating module, and transmits the second optical signal along the second path subsequent to dispersion compensation.

5. The system of claim 3, wherein the second circulator is further in optical communication with the first path, receives the first optical signal from the dispersion compensating module, and transmits the first optical signal along the first path subsequent to dispersion compensation.

6. The system of claim 1, wherein the dispersion compensating module comprises one or more of dispersion compensating fiber, one or more etalons, one or more fiber Bragg gratings, and a planar light-wave circuit.

7. The system of claim 1, wherein the dispersion compensating module is disposed at an amplifier site.

8. The system of claim 1, wherein the first optical signal and the second optical signal each comprise a wavelength division multiplexed optical signal.

9. A method for the bi-directional application of a dispersion compensating module in a regional system, comprising:
providing a dispersion compensating module configured to receive a first optical signal traveling along a first path and a second optical signal traveling along a second path, wherein the dispersion compensating module provides dispersion compensation to the first optical signal and the second optical signal.

10. The method of claim 9, further comprising:
providing a first circulator in optical communication with the dispersion compensating module and the first path, wherein the first circulator delivers the first optical signal to the dispersion compensating module.

11. The method of claim 10, further comprising:
providing a second circulator in optical communication with the dispersion compensating module and the second path, wherein the second circulator delivers the second optical signal to the dispersion compensating module.

12. The method of claim 11, wherein the first circulator is further in optical communication with the second path, receives the second optical signal from the dispersion compensating module, and transmits the second optical signal along the second path subsequent to dispersion compensation.

13. The method of claim 11, wherein the second circulator is further in optical communication with the first path, receives the first optical signal from the dispersion compensating module, and transmits the first optical signal along the first path subsequent to dispersion compensation.

14. The method of claim 9, wherein the dispersion compensating module comprises one or more of dispersion compensating fiber, one or more etalons, one or more fiber Bragg gratings, and a planar light-wave circuit.

15. The method of claim 9, disposing the dispersion compensating module at an amplifier site.

16. The method of claim 9, wherein the first optical signal and the second optical signal each comprise a wavelength division multiplexed optical signal.

17. A dispersion compensating system, comprising:
an optical device configured to receive an optical signal traveling in a first direction, provide first dispersion compensation to the optical signal, receive the optical signal traveling in a second direction, and provide second dispersion compensation to the optical signal.

18. The system of claim 17, further comprising:
a mirror for changing the direction of travel of the optical signal from the first direction to the second direction.

19. The system of claim 18, wherein the mirror comprises a Faraday mirror.

20. The system of claim 17, further comprising:
a circulator in optical communication with a first path and a second path, wherein the circulator receives the optical signal traveling in the first direction from the first path and delivers the optical signal traveling in the first direction to the optical device.

21. The system of claim 20, wherein the circulator further receives the optical signal traveling in the second direction from the optical device and transmits the optical signal traveling in the second direction along the second path.

22. The system of claim 17, wherein the optical device comprises a dispersion compensating module.

23. A dispersion compensating method, comprising:
providing an optical device configured to receive an optical signal traveling in a first direction, provide first dispersion compensation to the optical signal, receive the optical signal traveling in a second direction, and provide second dispersion compensation to the optical signal.

24. The method of claim 23, further comprising:
providing a mirror for changing the direction of travel of the optical signal from the first direction to the second direction.

25. The method of claim 24, wherein the mirror comprises a Faraday mirror.

26. The method of claim 23, further comprising:
providing a circulator in optical communication with a first path and a second path, wherein the circulator receives the optical signal traveling in the first direction from the first path and delivers the optical signal traveling in the first direction to the optical device.

27. The method of claim 26, wherein the circulator further receives the optical signal traveling in the second direction from the optical device and transmits the optical signal traveling in the second direction along the second path.

28. The method of claim 23, wherein the optical device comprises a dispersion compensating module.
